(19) United States
(12) Patent Application Publication
(10) Pub. No.: US 2025/0272164 A1
(43) Pub. Date: Aug. 28, 2025

(54) CODE GENERATION TO MANAGE EVOLUTION OF APPLICATION PROGRAMMING INTERFACE

(71) Applicant: Oracle International Corporation, Redwood Shores, CA (US)

(72) Inventors: Bence Czipó, Zurich (CH); Utku Gorkem Erturk, Echandens (CH); Hugo Guiroux, Zurich (CH)

(21) Appl. No.: 18/783,504

(22) Filed: Jul. 25, 2024

Related U.S. Application Data
(60) Provisional application No. 63/558,484, filed on Feb. 27, 2024.

(51) Int. Cl. G06F 9/54

(52) U.S. Cl. CPC G06F 9/541

(57) ABSTRACT

Disclosed herein is a programming framework that addresses the challenges of managing breaking changes in API versioning. A breaking change between a first version of an application programming interface (API) and a second version of the API may be detected. One or more mapper functions associated with the first version of the API and the second version of the API may be generated. A first version request may be received from a client computing device, wherein the first version request is compatible with the first version of the API. The first version request may be converted, via the one or more mapper functions, to a second version request, wherein the second version request is compatible with the second version of the API. The second version request may be provided to an endpoint of the API, and a second version response may be received from the endpoint of the API. The second version response may be compatible with the second version of the API. The second version response may be converted, via the one or more mapper functions, to a first version response, wherein the first version response is compatible with the first version of the API. The first version response may be provided to the client computing device,

### BENEFIT CLAIM

This application claims the benefit of U.S. Provisional Application No. 63/558,484 entitled ANNOTATION BASED CODE GENERATION METHOD TO MANAGE SCHEMA EVOLUTION OF REST APIS, filed Feb. 27, 2024, the contents of which are incorporated by reference for all purposes as if fully set forth herein.

### TECHNICAL FIELD

The present disclosure relates to managing versions of an application programming interface.

### BACKGROUND

In the constantly evolving landscape of software development, application programming interfaces (APIs) are pivotal for ensuring seamless interaction between different software components. But as APIs evolve over time, changes in their structure and functionality can introduce significant challenges. The most pressing of these challenges is the management of breaking changes. A breaking change is a modification made to an API that causes the resulting version of the API to be incompatible with previous versions of that API that are now deprecated. The introduction of a breaking change can cause clients that use the deprecated version of the API to experience errors or malfunctions. Thus, with each new release, there is a risk that changes to an API schema could render the API incompatible with existing client implementations. And because clients are not controlled by the API provider, clients cannot be forced to update.

Attempting to prevent the introduction of breaking changes can cause further issues. Identifying structural and semantical breaking changes between versions of an API involves thorough and often manual inspection. Detecting breaking changes is therefore time-consuming and prone to error, and system failures can still occur if any breaking changes are not identified. Once identified, resolving breaking changes means developing bridging code. Developing bridging code typically involves manually crafting functions that map requests and responses between different versions of the API. This task can also be complex and time-consuming.

The complexity of managing breaking changes is further compounded by several factors. For example, an API can undergo changes of diverse type and scope, such as renaming elements, changing data types, or altering request and response structures. As another example, developers dependent on a deprecated version of an API need sufficient time to transition to a newer version, which can lengthen the process of deprecating the previous version. During the timeframe developers are given to update, the API provider has to maintain backwards compatibility with both the immediate predecessor to the new API version and any other deprecated versions released during that timeframe. To give a further example, the increasing speed of software development cycles demands more frequent API updates and thus more chances for breaking changes.

API version management can be inefficient and entails extensive, manual developer intervention, both in identifying breaking changes and reconciling old API versions with the new version. Maintaining multiple servers, each with a different version of the API is clunky and resource intensive. Thus, a more efficient and automated approach that can handle the nuances of API version compatibility is needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that illustrates an example of a network environment, according to various embodiments of the present disclosure.

FIG. 2 is a block diagram that illustrates an example of chained mapper functions, according to various embodiments of the present disclosure.

FIG. 3A illustrates an example of an extension of an API specification, according to various embodiments of the present disclosure.

FIG. 3B illustrates an example of a mapper function, according to various embodiments of the present disclosure.

FIG. 4A illustrates an example of an extension of an API specification, according to various embodiments of the present disclosure.

FIG. 4B illustrates an example of a mapper function, according to various embodiments of the present disclosure.

FIG. 5 is a flow diagram that depicts an example of the operation of a portion of a code generator, according to various embodiments of the present disclosure.

FIG. 6 is a block diagram that illustrates a computer system upon which an embodiment of the invention may be implemented.

FIG. 7 is a block diagram of a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Disclosed herein is a programming framework that addresses the challenges of managing breaking changes in API versioning. The disclosed programming framework uses API specifications, which are universally-recognized and language-independent blueprints for representational state transfer (RESTful) APIs. The programming framework compares different versions of an API to identify any breaking changes. Upon detecting one or more breaking changes, the programming framework generates one or more mapper functions that bridge the compatibility gap between the different versions of the API. In some examples, the content of a mapper function can be fully generated from an API specification. In other examples, a developer can write all the custom migration logic in the mapper function.

The disclosed programming framework reduces manual effort in managing breaking changes by providing an annotation-based solution. The programming framework streamlines the process of ensuring API version compatibility, thereby enhancing the developer experience, reducing the risk of integration failures, and improving the maintainability and reliability of software systems reliant on evolving APIs. The disclosed programming framework is especially beneficial in fast-paced software development environments where frequent API updates are common. Thus, the programming framework ensures seamless integration and backwards compatibility across multiple API versions.

### System Overview

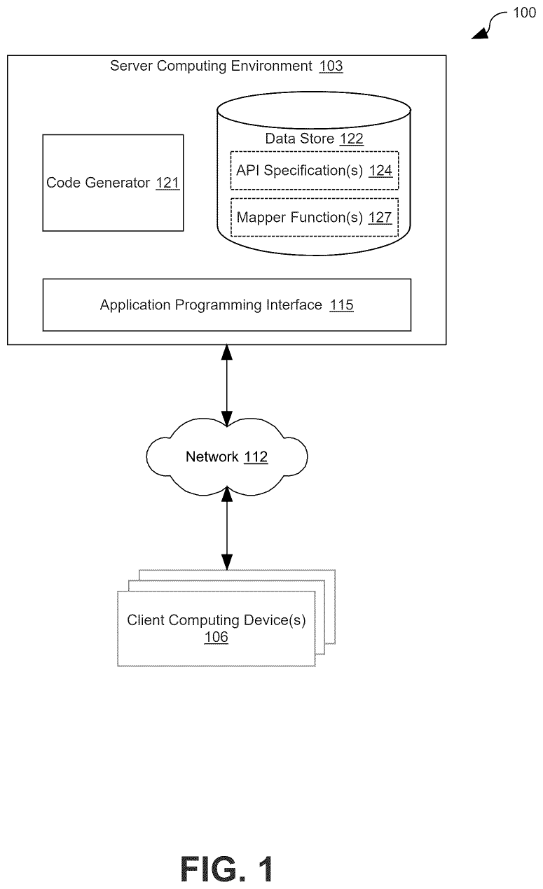

FIG. 1 illustrates a block diagram depicting an example of a network environment 100 according to various embodiments of the present disclosure. The network environment 100 may include a server computing environment 103, one or more client computing devices 106, and potentially other components in communication via a network 112.

The network 112 includes the Internet, intranets, extranets, wide area networks (WANs), local area networks (LANs), wired networks, wireless networks, other suitable networks, or any combination of two or more such networks. The networks may include satellite networks, cable networks, Ethernet networks, and other types of networks.

The server computing environment 103 may include a single server computing device that provides computing capabilities. Alternatively, the server computing environment 103 may employ multiple server computing devices that are arranged in one or more server banks or computer banks. In one example, the computing devices may be located in a single installation. In another example, the computing devices for the server computing environment 103 may be distributed among multiple different geographical locations. In one case, the server computing environment 103 may include multiple computing devices that together may form a hosted computing resource or a grid computing resource. In addition, the server computing environment 103 may operate as an elastic computing resource where the allotted capacity of computing-related resources, such as processing resources, network resources, and storage resources, may vary over time. In other examples, the server computing environment 103 may include or be operated as one or more virtualized computer instances that may be executed to perform the functionality that is described herein.

Various applications or other functionality may be executed in the server computing environment 103. Components executed in the server computing environment 103 may include an API 115, a code generator 121, and other applications, services, processes, systems, engines, or functionality not discussed in detail herein.

In addition, various data may be stored in a data store 122 that is accessible to the server computing environment 103. The data store 121 may be representative of a plurality of data stores 121. The data stored in the data store 121 may be associated with the operation of the various applications or functional entities described below. Data stored in the data store may include, for example, one or more API specifications 124 and one or more mapper functions 127.

The client computing device 106 may represent multiple client devices 106 coupled to the network 112. The client computing device 106 may include a processor-based system, such as a computer system, that may include a desktop computer, a laptop computer, a personal digital assistant, a cellular telephone, a smartphone, a set-top box, a music player, a tablet computer system, a game console, an electronic book reader, or any other device with like capability. The client computing device 106 may also be equipped with networking capability or networking interfaces, including a localized networking or communication capability, such as a near-field communication (NFC) capability, radio-frequency identification (RFID) read or write capability, or other localized communication capability.

### API Specification

An API specification 124 may define the structure and operations of a particular version of the API 115. Each version of the API 115 may have its own distinct API specification 124. The API specification 124 may be, for example, an OpenAPI specification (formerly known as a Swagger specification), a RESTful API Modeling Language (RAML) specification, or any other suitable documentation format for describing the features and behavior of an API. The code generator 121 may generate source code that implements the API 115 from the API specification 115.

An API specification 124 may include one or more extensions. For example, an extension may comprise a definition of a breaking change associated with an endpoint of the API 115. An API specification 124 for a deprecated version of the API 115 may include an extension for an endpoint in the deprecated version of the API 115; that extension may identify the corresponding endpoint in the succeeding version of the API 115 and indicate the breaking change that is present in the succeeding version of the API 115. Note that, while the terms “succeeding version” is used herein to reference an API 115 version that replaced an immediate previous API 115 version that is now deprected, that succeeding version of the API 115 may, in some examples, also be deprecated when a further succeeding version of the API 115 has been implemented.

### Breaking Changes

A breaking change may comprise any modification made to the API 115 that causes the resulting succeeding version of the API 115 to be incompatible with the previous version of the API 115 without that modification of code invoking the API. The breaking change may affect one or more endpoints of the API 115. When the client computing device 106, using the deprecated version of the API 115, makes a request to the affected endpoint, the breaking change will cause the request to fail.

The detection tool 118 may be configured to detect breaking changes. The detection tool 118 may compare an API specification 124 for a previous version of the API 115 and an API specification 124 for a newer version of the API 115. The detection tool 118 may thereby detect any differences between the two API specification 124. The detection tool 118 may categorize any such differences as breaking changes or non-breaking changes. In some implementations, the detection tool 118 may detect breaking changes using a version controlling system.

For example, the detection tool 118 may be configured to detect: a parameter or an object in a deprecated version of the API 115 being renamed in a succeeding version of the API 115, a data type of a parameter or an object in the first version being changed in the second version, a size of a field in the first version being decreased in the second version, an endpoint in the first version being removed in the second version, a parameter in the first version being designated as required in the second version, a required parameter being added to the second version, a default value of a parameter in the first version of the API being change in the second version, a check constraint being added to the second version, or an input method in the first version being changed in the second version. These types of breaking changes are, however, merely examples, and the detection tool 118 may be configured to detect other types of breaking changes as desired.

### Mapper Functions

The code generator 121 may be configured to generate mapper functions 127. The code generator 121 automatically generates one or more mapper functions 127 when the detection tool 118 detects one or more breaking changes. A mapper function 127 may act as a “translator layer” between client devices 106 using deprecated versions of the API 115 and the server computer 103. That is, the mapper function 127 may convert requests and responses between different versions of the API 115.

After one or more breaking changes are detected, the code generator 121 may generate mapper functions based on the API specification 124 of the deprecated version of the API 115. If the API specification 124 includes an extension associated with the breaking change, then the code generator 121 may generate a definition for each mapper function 127 and an implementation of each mapper function 127. If, however, the API specification 124 does not include an annotation associated with the breaking change, then the code generator 121 may generate only a definition for each mapper function 127. In the latter case, a developer may then provide code to implement the mapper functions 127.

In some implementations, the code generator 121 may generate a mapper function 127 to handle requests and a mapper function 127 to handle responses. In other implementations, the code generator 121 may generate a single mapper function 127 that handles both requests and responses.

As an example, the code generator 121 may generate a request mapper function 127. A request mapper function 127 may translate a request from a format used in a deprecated version of the API 115 to a format compatible with a succeeding version of the API 115. For instance, when a request is made to version 1 of an API 115, the request mapper conversion converts the request to a format that is compatible with version 2 of the API 115. Thus, the request mapper function 127 may ensure that version 2 of the API 115 can process requests that use version 1 of the API 115.

As another example, the code generator 121 may generate a response mapper function 127. A response mapper function 127 may convert a response generated by a succeeding version of the API 115 to a format that is compatible with a deprecated version of the API 115. For instance, when version 2 of an API 115 generates a response to a request made for version 1 of the API 115, the response mapper function 127 converts the response to a format that is compatible with version 1 of the API 115.

### Chained Mapper Functions

In examples where compatibility is maintained between three or more different versions of an API 115, the mapper functions 127 for those versions may be “chained” together ordinally. When receiving a request in an oldest version of the API, a request mapper function 127 may convert the request to one or more intermediate versions of the API 115 and then to a newest version of the API 115.

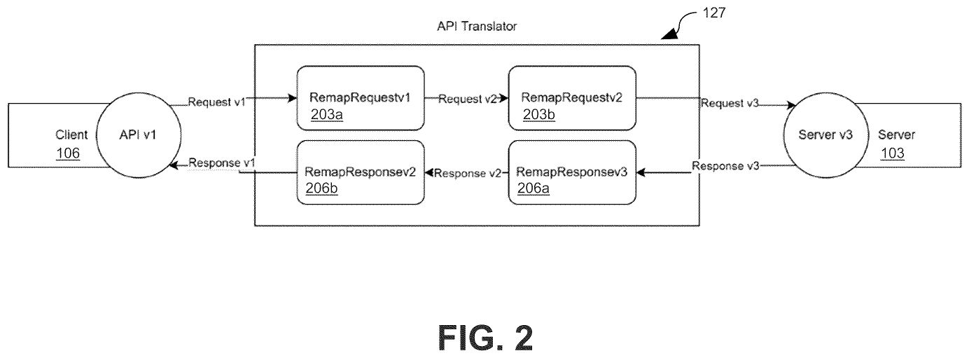

FIG. 2 illustrates an example of chained mapper functions 127 according to various embodiments of the present disclosure. In this example, the API 115 has three versions: version 1, version 2, and version 3. When the client device 106 using version 1 of the API 115 makes a request, a first request mapper function 203a converts the request from a format compatible with version 1 of the API 115 to a format compatible with version 2 of the API 115. Then, a second request mapper function 203b converts the request from the format compatible with version 2 of the API 115 to a format compatible with version 3 of the API 115. The request may then be passed on to the server computing environment 103 using version 3 of the API 115. Note that, while the various mapper functions 203 and 206 are shown as separate from the server computing environment 103 for purposes of illustration, those mapper functions 203 and 206 may themselves be components of the server computing environment 103 or of an API gateway.

Likewise, when the server computing environment 103 using version 3 of the API 115 generates a response to the request, a first response mapper function 206a converts the response from a format compatible with version 3 of the API 115 to a format compatible with version 2 of the API 115. Then, a second response mapper function 206b converts the response from the format compatible with the second version of the API 115 to a format compatible with the first version of the API 115. The request may then be passed to the client computing device 106 using the first version of the API 115.

### Illustrative Examples of Detecting and Resolving Breaking Changes

Consider an example of an API 115 named “Pet API”. Pet API enables tracking of information regarding pets. A first version of Pet API, “v1”, includes an endpoint, “v1/pet/add”, designed to register a pet by accepting its name and age. The developers of Pet API use the code generator 121 to generate an API specification 124 for v1.

Later, the developers decide to require a pet's weight to register. To that end, the developers implement a second version of Pet API, “v2”, which modifies the v1/pet/add endpoint to register a pet by accepting its name, age, and weight. This modification constitutes a breaking change because a request using v1, which would include only a pet's name and age, would fail to register the pet in v2, which requires the pet's weight in addition to its name and age.

To manage the breaking change, the developers of Pet API use the code generator 121 to generate an API specification 124 for v2 that incorporates the modification to the v1/pet/add endpoint. The developers then execute the code generator 121 on both the API specification 124 for v1 and the API specification 124 for v2. The code generator 121 first detects any breaking changes between v1 and v2. In this case, the code generator 121 detects a breaking change in the v2/pet/add endpoint compared to the v1/pet/add endpoint.

The code generator 121 then generates mapper functions 127 to convert between requests from the v1/pet/add endpoint and responses from the v2/pet/add endpoint. The code generator 121 may generate both a request mapper function and a response mapper function. In some examples, the code generator 121 generates both a definition of each mapper function 127 and an implementation of each mapper function 127. In other examples, however, the code generator 121 generates only a definition of each mapper function 127. In the latter case, the developers then implement each mapper function 127 by, for example, assigning a default value for weight. This allows requests using v1 to be compatible with v2-a v1 request will include only a pet's name and age, but the mapper functions 127 will register the pet with the default weight in addition to the specified name and age.

Thus, requests using both v1 and v2 may be served. For future versions of Pet API, the developers may implement new mapper functions 127 automatically created by the code generator 121 while maintaining the existing mapper functions 127.

Next, consider an example involving a breaking change that results from an endpoint being renamed. In v1 of Pet API, there exists an endpoint, “/pet/findBySurname”. In v2 of Pet API, however, that endpoint is renamed to “/pet/findByLastname”. This modification constitutes a breaking change because v2 would be unable to process requests to the /pet/findBySurname endpoint.

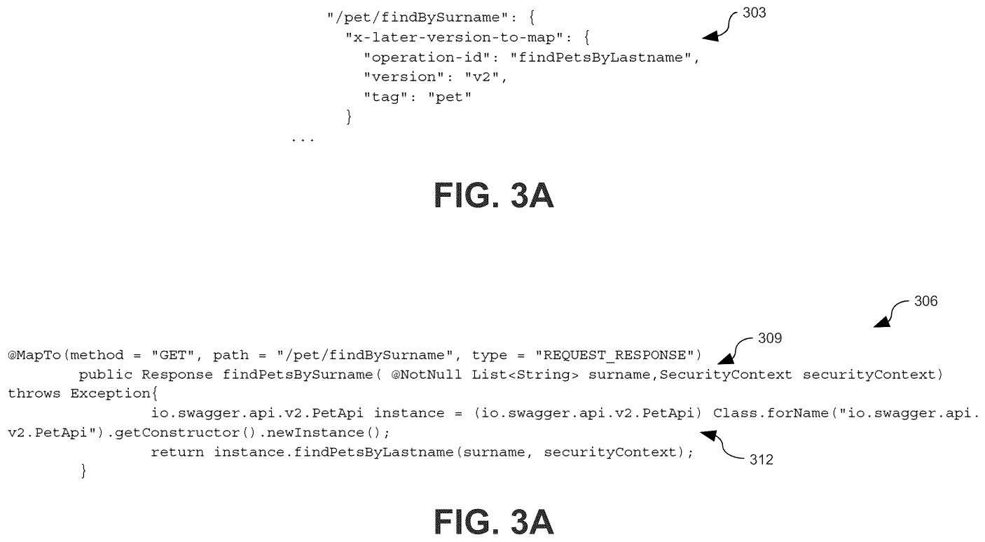

To handle this breaking change, the developers of Pet API add an extension, “x-later-version-to-map”, to v1's API specification 124. FIG. 3A shows an example of the x-later-version-to-map extension 303, which links the /pet/findBySurname endpoint in v1 to its counterpart in v2, the /pet/findByLastname endpoint.

Then, the code generator 121 automatically generates a request-response mapper function 306, as shown in the example of FIG. 3B, which converts requests using v1 to be compatible with v2 and converts responses using v2 to be compatible with v1. The mapper function 306 maps /pet/FindBySurname endpoint in v1 to the /pet/FindByLastname endpoint in v2. The mapper function 306 includes a definition 309 and an implementation 312. The mapper function 306 ensures seamless functioning of Pet API and backwards compatibility without manual intervention.

Next, assume that there is a breaking change that results from the data type of an endpoint being changed. For instance, the developers of Pet API decide to change an endpoint that finds pets based on a date, “/pet/findByDate”, to accept dates in a different format. In this example, v1/pet/findByDate accepts dates in a “yy/MM/dd HH:mm” format, but v2/pet/findByDate accepts dates in a “dd/MM/yy HH:mm” format. This constitutes a breaking change because a request using v1 that includes a date with the “yy/MM/dd HH:mm” format would not be accepted by v2, which expects dates to be in a “dd/MM/yy HH:mm” format.

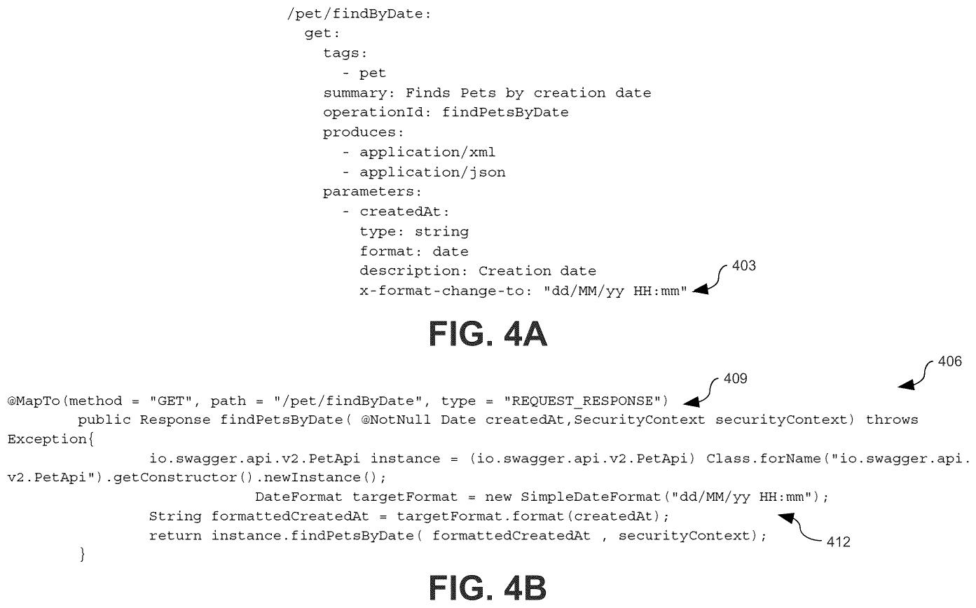

To handle this breaking change, the developers add an extension, x-format-change-to”, in the API specification 124 for v1. FIG. 4A shows an example of the x-format-change-to extension 403, which links the v1/pet/findByDate endpoint with the v2/pet/findByDate endpoint.

The code generator 121 then automatically generates a request-response mapper function 406, as shown in the example of FIG. 3B. The mapper function 406 converts requests using v1 to be compatible with v2 and converts responses using v2 to be compatible with v1. The mapper function 406 maps v1/pet/findByDate to v2/pet/findByDate. The mapper function 406 includes a definition 409 and an implementation 412. The mapper function 406 automatically reformats v1 requests using the “yy/MM/dd HH:mm” format to v2's “dd/MM/yy HH:mm” format, and vice-versa with responses. As in the example of FIG. 3B, the mapper function 406 in FIG. 4B ensures seamless functioning of Pet API and backwards compatibility without manual intervention.

### Example Process for Detecting and Resolving Breaking Changes

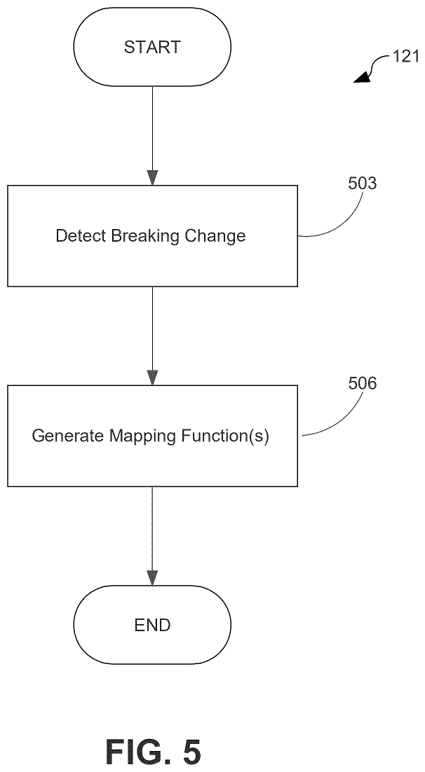

FIG. 5 is a flow diagram that depicts an example of the operation of a portion of the server computing environment, according to various embodiments of the present disclosure. The flow diagram of FIG. 5 provides merely an example of the many different types of functional arrangements that may be employed to implement the operation of the depicted portion of the server computing environment 103. As an alternative, the flow diagram of FIG. 5 may be viewed as depicting an example of elements of a method implemented within the networked environment 100.

At step 503, detection tool 118 detects a breaking change between two versions of the API 115. The two versions of the API 115 include a deprecated version and a succeeding version. The detection tool 118 is executed on an API specification 124 for the deprecated version and an API specification 124 for the succeeding version. By comparing these two API specification 124, the detection tool 118 may identify a modification of the deprecated version that is present in the succeeding version. The detection tool 118 may then categorize the modification as a breaking change, as opposed to a non-breaking change. For example, the detection tool 118 may identify an extension in the API specification 124 for the deprecated version that links an endpoint in the deprecated version with a counterpart endpoint in the succeeding version. The detection tool 118 may determine that a modification to the endpoint reflected in the counterpart endpoint constitutes a breaking change.

At step 506, the code generator 121 generates one or more mapper functions 127. The one or more mapper functions 127 may convert a request compatible with the deprecated version to a request compatible with the succeeding version. Likewise, the one or more mapper functions 127 may convert a response compatible with the succeeding version to a response compatible with the deprecated version.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

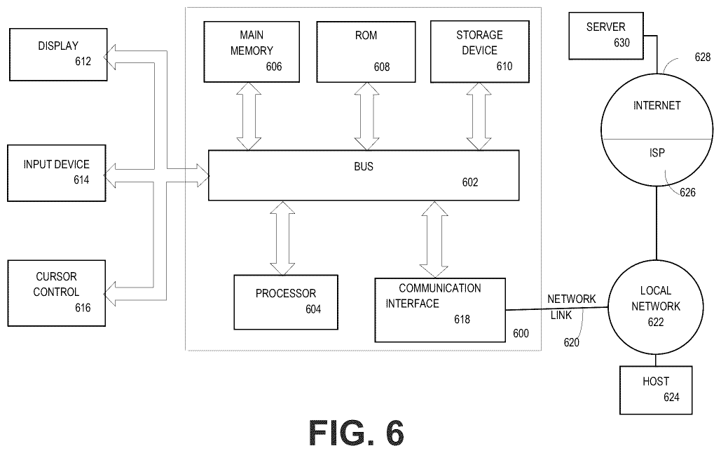

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

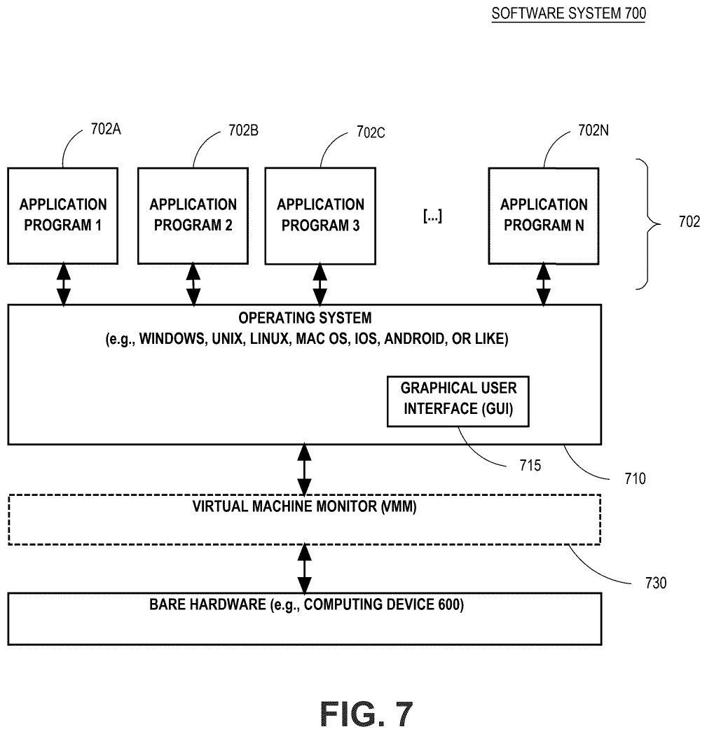

FIG. 7 is a block diagram of a basic software system 700 that may be employed for controlling the operation of computing system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computing system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 700 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software and computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
detecting a breaking change between a first version of an application programming interface (API) and a second version of the API;
generating one or more mapper functions associated with the first version of the API and the second version of the API;
receiving a first version request from a client computing device, wherein the first version request is compatible with the first version of the API;
converting, via the one or more mapper functions, the first version request to a second version request, wherein the second version request is compatible with the second version of the API;
providing the second version request to an endpoint of the API;
receiving a second version response from the endpoint of the API, wherein the second version response is compatible with the second version of the API;
converting, via the one or more mapper functions, the second version response to a first version response, wherein the first version response is compatible with the first version of the API; and
providing the first version response to the client computing device,
wherein the method is performed by one or more computing devices.

2. The method of claim 1, wherein the breaking change comprises a modification to the API that causes the second version of the API to be incompatible with the first version of the API.

3. The method of claim 2, wherein the modification comprises:
a parameter or an object in the first version of the API being renamed in the second version;
a data type of the parameter or the object in the first version of the API being changed in the second version of the API;
a size of a field in the first version of the API being decreased in the second version of the API;
an endpoint in the first version of the API being removed in the second version of the API;
the parameter in the first version of the API being designated as required in the second version of the API;
a required parameter being added to the second version of the API;
a default value of the parameter in the first version of the API being change in the second version of the API;
a check constraint being added to the second version of the API; or
an input method in the first version of the API being changed in the second version of the API.

4. The method of claim 1, wherein the modification to the API comprises a modification to the endpoint of the API.

5. The method of claim 1, wherein the one or more mapper functions comprise a request mapper function and a response mapper function, and wherein:
the first version request is converted to the second version request via the request mapper function; and
the second version response is converted to the first version response via the response mapper function.

6. The method of claim 1, wherein the one or more mapper functions comprise one or more first mapping functions, the method further comprising:
detecting a breaking change between the second version of the API and a third version of the API;
generating one or more second mapper functions associated with the second version of the API and the third version of the API;
receiving another first version request from the client computing device, wherein the other first version request is compatible with the first version of the API;
converting, via the one or more first mapper functions, the other first version request to another second version request, wherein the other second version request is compatible with the second version of the API;
converting, via the one or more second mapper functions, the other second version request to a third version request, wherein the third version request is compatible with the third version of the API;
providing the third version request to the endpoint of the API;
receiving a third version response from the endpoint of the API, wherein the third version response is compatible with the third version of the API;
converting, via the one or more second mapper functions, the third version response to another second version response, wherein the other second version response is compatible with the second version of the API;
converting, via the one or more first mapper functions, the other second version response to another first version response, wherein the other first version response is compatible with the first version of the API; and
providing the other first version response to the client computing device.

7. The method of claim 1, wherein the one or more mapper functions are generated based at least in part on an extension in an API specification associated with the first version of the API, the extension defining the breaking change.

8. The method of claim 1, wherein generating the one or more mapper functions further comprises automatically generating source code comprising a definition of the one or more mapper functions, and source code comprising an implementation of the one or more mapper functions is received from a user.

9. The method of claim 1, wherein generating the one or more mapper functions further comprises:
automatically generating source code comprising a definition of the one or more mapper functions; and
automatically generating source code comprising an implementation of the one or more mapper functions.

10. The method of claim 1, wherein:
the first version request is incompatible with the second version of the API;
the second version request is incompatible with the first version of the API;
the second version response is incompatible with the first version of the API; and
the first version response is incompatible with the second version of the API.

11. One or more non-transitory storage media storing instructions which, when executed by one or more computing devices, cause:
detecting a breaking change between a first version of an application programming interface (API) and a second version of the API;
generating one or more mapper functions associated with the first version of the API and the second version of the API;
receiving a first version request from a client computing device, wherein the first version request is compatible with the first version of the API;
converting, via the one or more mapper functions, the first version request to a second version request, wherein the second version request is compatible with the second version of the API;
providing the second version request to an endpoint of the API;
receiving a second version response from the endpoint of the API, wherein the second version response is compatible with the second version of the API;
converting, via the one or more mapper functions, the second version response to a first version response, wherein the first version response is compatible with the first version of the API; and
providing the first version response to the client computing device.

12. The one or more non-transitory storage media of claim 11, wherein the breaking change comprises a modification to the API that causes the second version of the API to be incompatible with the first version of the API.

13. The one or more non-transitory storage media of claim 12, wherein the modification comprises:
a parameter or an object in the first version of the API being renamed in the second version;
a data type of the parameter or the object in the first version of the API being changed in the second version of the API;
a size of a field in the first version of the API being decreased in the second version of the API;
an endpoint in the first version of the API being removed in the second version of the API;
the parameter in the first version of the API being designated as required in the second version of the API;
a required parameter being added to the second version of the API;
a default value of the parameter in the first version of the API being change in the second version of the API;
a check constraint being added to the second version of the API; or
an input method in the first version of the API being changed in the second version of the API.

14. The one or more non-transitory storage media of claim 11, wherein the modification to the API comprises a modification to the endpoint of the API.

15. The one or more non-transitory storage media of claim 11, wherein the one or more mapper functions comprise a request mapper function and a response mapper function, and wherein:
the first version request is converted to the second version request via the request mapper function; and
the second version response is converted to the first version response via the response mapper function.

16. The one or more non-transitory storage media of claim 11, wherein the one or more mapper functions comprise one or more first mapping functions, the method further comprising:
detecting a breaking change between the second version of the API and a third version of the API;
generating one or more second mapper functions associated with the second version of the API and the third version of the API;
receiving another first version request from the client computing device, wherein the other first version request is compatible with the first version of the API;
converting, via the one or more first mapper functions, the other first version request to another second version request, wherein the other second version request is compatible with the second version of the API;
converting, via the one or more second mapper functions, the other second version request to a third version request, wherein the third version request is compatible with the third version of the API;
providing the third version request to the endpoint of the API;
receiving a third version response from the endpoint of the API, wherein the third version response is compatible with the third version of the API;
converting, via the one or more second mapper functions, the third version response to another second version response, wherein the other second version response is compatible with the second version of the API;
converting, via the one or more first mapper functions, the other second version response to another first version response, wherein the other first version response is compatible with the first version of the API; and
providing the other first version response to the client computing device.

17. The one or more non-transitory storage media of claim 11, wherein the one or more mapper functions are generated based at least in part on an extension in an API specification associated with the first version of the API, the extension defining the breaking change.

18. The one or more non-transitory storage media of claim 11, wherein generating the one or more mapper functions further comprises automatically generating source code comprising a definition of the one or more mapper functions, and source code comprising an implementation of the one or more mapper functions is received from a user.

19. The one or more non-transitory storage media of claim 11, wherein generating the one or more mapper functions further comprises:
automatically generating source code comprising a definition of the one or more mapper functions; and
automatically generating source code comprising an implementation of the one or more mapper functions.

20. The one or more non-transitory storage media of claim 11, wherein:
the first version request is incompatible with the second version of the API;
the second version request is incompatible with the first version of the API;
the second version response is incompatible with the first version of the API; and
the first version response is incompatible with the second version of the API.
